(19) United States
(12) Patent Application Publication
(10) Pub. No.: US 2026/0367244 A1
(43) Pub. Date: Nov. 19, 2026

(54) WARNING DEVICE AND STORAGE MEDIUM

(71) Applicants: TOYOTA JIDOSHA KABUSHIKI KAISHA, Toyota-shi (JP); DENSO CORPORATION, Kariya-city (JP)

(72) Inventor: Hiroki SHIMAZU, Nisshin-shi (JP)

(73) Assignees: TOYOTA JIDOSHA KABUSHIKI KAISHA, Toyota-shi (JP); DENSO CORPORATION, Kariya-city (JP)

(21) Appl. No.: 19/665,127

(22) Filed: May 1, 2026

(30) Foreign Application Priority Data
May 15, 2025 (JP) 2025-082127

(51) Int. Cl. G01S 13/931; G08G 1/16

(52) U.S. Cl. CPC G01S 13/931; G08G 1/16

(57) ABSTRACT

A warning device configured to issue a warning to a user of a vehicle when an object is present around the vehicle includes: an object detection unit configured to detect objects around the vehicle; and a warning unit configured to issue a warning to the user of the vehicle based on an object detected by the object detection unit. The warning unit is configured to, in a case where the object detected by the object detection unit is estimated to be an automobile, issue a warning when the object is located within a predetermined normal warning region to the side of the vehicle, and in a case where the object detected by the object detection unit is estimated to be a two-wheeled vehicle, issue a warning when the object is located within an extended warning region obtained by extending the normal warning region.

### CROSS-REFERENCE TO RELATED APPLICATION

This application claims priority to Japanese Patent Application No. 2025-082127 filed on May 15, 2025. The disclosure of the above-identified application, including the specification, drawings, and claims, is incorporated by reference herein in its entirety.

### BACKGROUND

### 1. Technical Field

The present disclosure relates to warning device and storage media.

### 2. Description of Related Art

Conventionally, it has been considered to provide driving assistance to avoid contact between the host vehicle and a two-wheeled vehicle when the host vehicle starts traveling from a stopped state at an intersection and the distance between the intersection and a two-wheeled vehicle located behind the host vehicle falls below a threshold (Japanese Unexamined Patent Application Publication No. 2017-224164 (JP 2017-224164 A)).

### SUMMARY

When an object such as a two-wheeled vehicle is present to the side of a vehicle, the detection results obtained by a distance sensor such as a radar device may include errors in the detected length of the object. When such errors in the detected object length occur, the warning to the user may be delayed even though the object is actually present within a region in which a warning should be issued.

In view of the above issue, an object of the present disclosure is to suppress delays in issuing a warning to the user when an object is present within a region where a warning should be issued.

The gist of the present disclosure is as follows.
(1) A warning device configured to issue a warning to a user of a vehicle when an object is present around the vehicle, the warning device including: an object detection unit configured to detect objects around the vehicle; and a warning unit configured to issue a warning to the user of the vehicle based on an object detected by the object detection unit, wherein the warning unit is configured to, in a case where the object detected by the object detection unit is estimated to be an automobile, issue a warning to the user of the vehicle when the object is located within a predetermined normal warning region to the side of the vehicle, and in a case where the object detected by the object detection unit is estimated to be a two-wheeled vehicle, issue a warning to the user of the vehicle when the object is located within an extended warning region obtained by extending the predetermined normal warning region.
(2) The warning device according to (1), wherein the object detection unit is configured to detect objects based on output of a radar mounted on the vehicle.
(3) The warning device according to (2), wherein the object detection unit is configured to determine, based on the number of reflection points and reflection intensity from a single object detected by the radar, whether the single object is a two-wheeled vehicle.
(4) The warning device according to any one of (1) to (3), wherein the extended warning region is a region obtained by extending the predetermined normal warning region in a traveling direction of the vehicle.
(5) A storage medium storing a warning program that causes a warning to be issued to a user of a vehicle when an object is present around the vehicle, the warning program causing a computer to detect objects around the vehicle, in a case where a detected object is estimated to be an automobile, issue a warning to the user of the vehicle when the detected object is located within a predetermined normal warning region to the side of the vehicle, and in a case where the detected object is estimated to be a two-wheeled vehicle, issue a warning to the user of the vehicle when the detected object is located within an extended warning region obtained by extending the predetermined normal warning region.

The present disclosure can suppress delays in issuing a warning to the user when an object is present within a region where a warning should be issued.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically illustrating a warning system in which a warning device according to one embodiment is implemented;

FIG. 2 is a diagram illustrating an arrangement of sensors provided on a vehicle;

FIG. 3 is a functional block diagram of a processor of an electronic control unit (ECU);

FIG. 4A is a diagram schematically illustrating reflection points of radio waves transmitted from a millimeter-wave radar;

FIG. 4B is a diagram schematically illustrating reflection points of radio waves transmitted from a millimeter-wave radar;

FIG. 4C is a diagram schematically illustrating reflection points of radio waves transmitted from a millimeter-wave radar;

FIG. 4D is a diagram schematically illustrating reflection points of radio waves transmitted from a millimeter-wave radar;

FIG. 4E is a diagram schematically illustrating reflection points of radio waves transmitted from a millimeter-wave radar;

FIG. 5A is a diagram schematically illustrating a warning region used when a warning is issued;

FIG. 5B is a diagram schematically illustrating a warning region used when a warning is issued;

FIG. 5C is a diagram schematically illustrating a warning region used when a warning is issued; and

FIG. 6 is a flowchart illustrating a warning process.

### DETAILED DESCRIPTION OF EMBODIMENTS

Hereinafter, an embodiment will be described in detail with reference to the drawings. In the following description, like reference signs denote like components.

### Configuration of Warning System

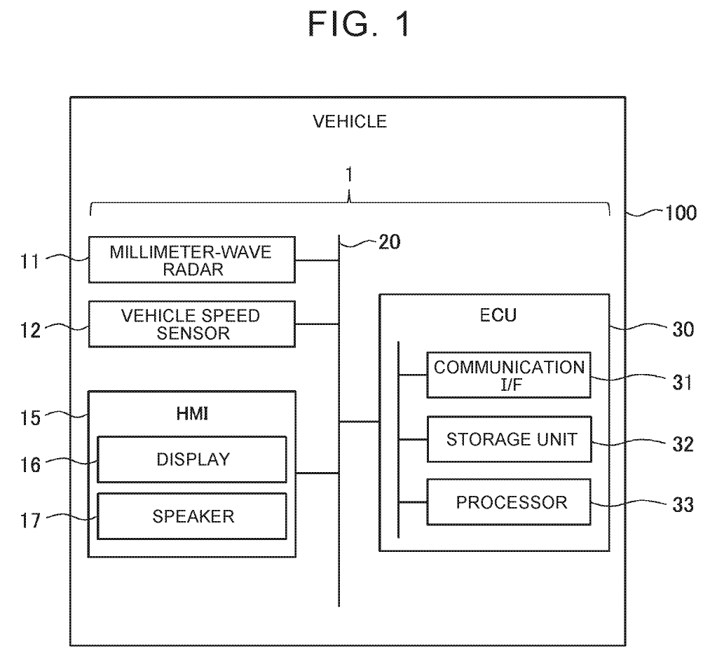

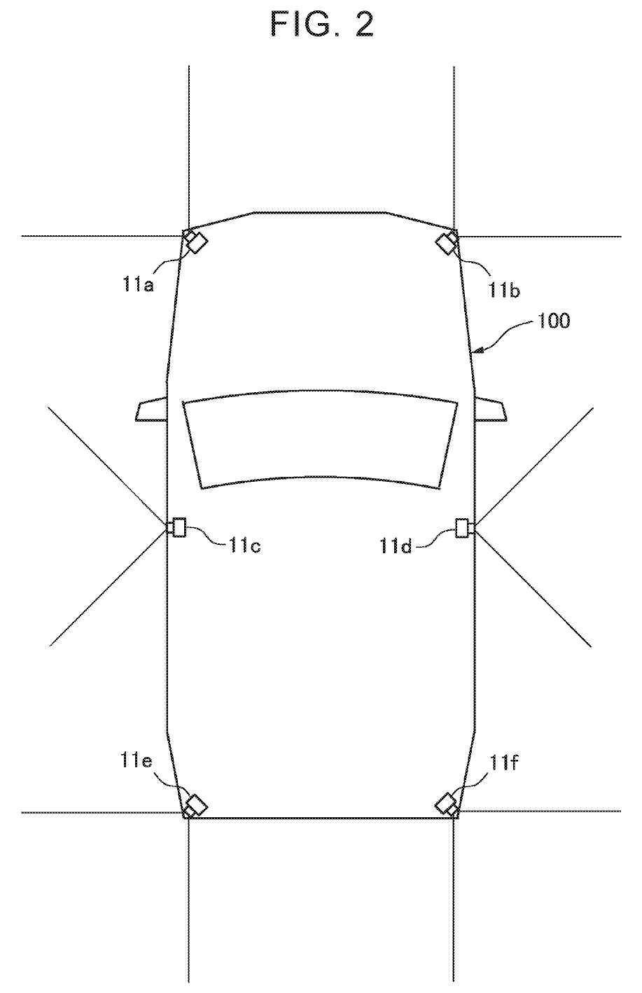

First, a warning system 1 in which a warning device according to one embodiment is implemented will be described with reference to FIGS. 1 and 2. FIG. 1 is a configuration diagram schematically illustrating the warning system 1 in which the warning device according to one embodiment is implemented. FIG. 2 is a diagram illustrating an arrangement of sensors provided on a vehicle 100. The warning system 1 is mounted on the vehicle 100 and issues a warning to occupants (users) of the vehicle 100. In particular, the warning system 1 issues a warning to the occupants of the vehicle 100 when a moving object is present to the side of the vehicle 100 (including front-side and rear-side regions relative to the vehicle 100).

As shown in FIG. 1, the warning system 1 includes a millimeter-wave radar 11, a vehicle speed sensor 12, a human-machine interface (HMI) 15, and an electronic control unit (ECU) 30. The millimeter-wave radar 11, the vehicle speed sensor 12, the HMI 15, and the ECU 30 are communicably connected, for example, via an in-vehicle network 20. The in-vehicle network 20 is, for example, a network compliant with standards such as Controller Area Network (CAN).

The millimeter-wave radar 11 is an example of a sensor that detects the distance to objects around the vehicle 100. The millimeter-wave radar 11 can also detect the direction in which objects around the vehicle 100 are located relative to the vehicle 100, and the relative speed of such objects with respect to the vehicle 100. As shown in FIG. 2, in the present embodiment, millimeter-wave radars 11 are provided one each at the left front part and the right front part of the vehicle 100 (11a, 11b), and detect objects located in the left front and right front regions relative the vehicle 100, respectively. Millimeter-wave radars 11 are also provided one each on the left side and the right side of the vehicle 100 (11c, 11d), and detect objects located to the left and right of the vehicle 100, respectively. Millimeter-wave radars 11 are also provided one each at the left rear part and the right rear part of the vehicle 100 (11e, 11f), and detect objects located in the left rear and right rear regions relative to the vehicle 100, respectively.

The millimeter-wave radar 11 transmits radio waves from a transmitting antenna and receives reflected waves using receiving antennas. The millimeter-wave radar 11 measures the distance to an object based on the time from transmission of the radio waves to reception of the reflected waves. The millimeter-wave radar 11 also measures the orientation of the object relative to the millimeter-wave radar 11 based on differences in reception of the reflected waves among the receiving antennas arranged side by side. The millimeter-wave radar 11 performs signal processing after mixing the radio waves transmitted from the transmitting antenna with the reflected waves received by the receiving antennas, generates output data related to position information of the object, and outputs the data to the ECU 30.

In the present embodiment, a millimeter-wave radar is used as a distance sensor that detects the distance to objects around the vehicle 100. However, other distance sensors such as ultrasonic sensors may be used.

The vehicle speed sensor 12 is an example of a sensor that detects the speed of the vehicle 100. The vehicle speed sensor 12 detects, for example, the rotational speed of wheels of the vehicle 100. The vehicle speed sensor 12 generates output data related to the speed of the vehicle 100 and outputs the data to the ECU 30.

The HMI 15 is an interface that inputs and outputs information between the occupants and the warning system 1. The HMI 15 includes an output device that outputs various types of information to the occupants, and an input device that allows the occupants to perform input operations.

Specifically, the HMI 15 includes, as an output device, a display 16 that displays character information or image information. The display 16 is a display device that displays images. The display 16 may be a liquid crystal display, an organic electroluminescence (EL) display, or any other type of display device. The display 16 is arranged, for example, on an instrument panel or a meter panel of the vehicle 100. The display 16 receives image signals from the ECU 30 via the in-vehicle network 20 and displays images in accordance with the image signals.

The HMI 15 also includes a speaker 17 as an output device. The speaker 17 is an example of a device that outputs audio. The speaker 17 receives audio signals from the ECU 30 via the in-vehicle network 20 and outputs audio in accordance with the audio signals. The HMI 15 may also include, as output devices, devices other than the display 16 and the speaker 17 that provide various types of information to the occupants (for example, a vibration device).

### Configuration of Warning Device

he ECU 30 functions as a warning device that issues a warning to the occupants of the vehicle 100. The ECU 30 executes a warning method for issuing a warning to the occupants of the vehicle 100. As shown in FIG. 2, the ECU 30 includes a communication interface 31, a storage unit 32, and a processor 33.

The communication interface 31 is a circuit that connects the ECU 30 to the in-vehicle network 20.

The storage unit 32 is an example of a non-transitory storage medium that stores data. The storage unit 32 includes, for example, at least one of the following storage media: volatile semiconductor memory, nonvolatile semiconductor memory, a hard disk drive (HDD), and a solid-state drive (SSD). The storage unit 32 stores computer programs executed by the processor 33 of the ECU 30. The storage unit 32 also stores data used by the computer programs executed by the processor 33, such as data transmitted from various sensors. A warning program according to the present disclosure is stored in a storage medium.

The processor 33 includes one or more central processing units (CPUs) and peripheral circuits thereof. The processor 33 may further include other arithmetic circuits such as a logic operation unit or a numerical operation unit. The processor 33 executes various processes based on computer programs stored in the storage unit 32.

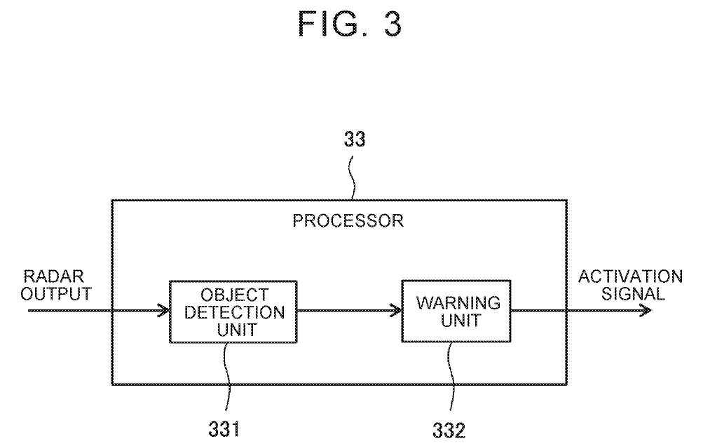

FIG. 3 is a functional block diagram of the processor 33 of the ECU 30. As shown in FIG. 3, the processor 33 includes an object detection unit 331 and a warning unit 332. These units of the processor 33 are functional modules realized, for example, by computer programs running on the processor 33. Alternatively, each unit of the processor 33 may be implemented in the ECU 30 as a separate integrated circuit, microprocessor, or firmware.

The object detection unit 331 detects objects around the vehicle 100. In particular, in the present embodiment, the object detection unit 331 detects moving objects around the vehicle 100 based on output data from the millimeter-wave radar 11. As described above, the millimeter-wave radar 11 detects objects based on the time until reception of reflected waves of radio waves transmitted from the transmitting antenna and the orientation of the reflected waves.

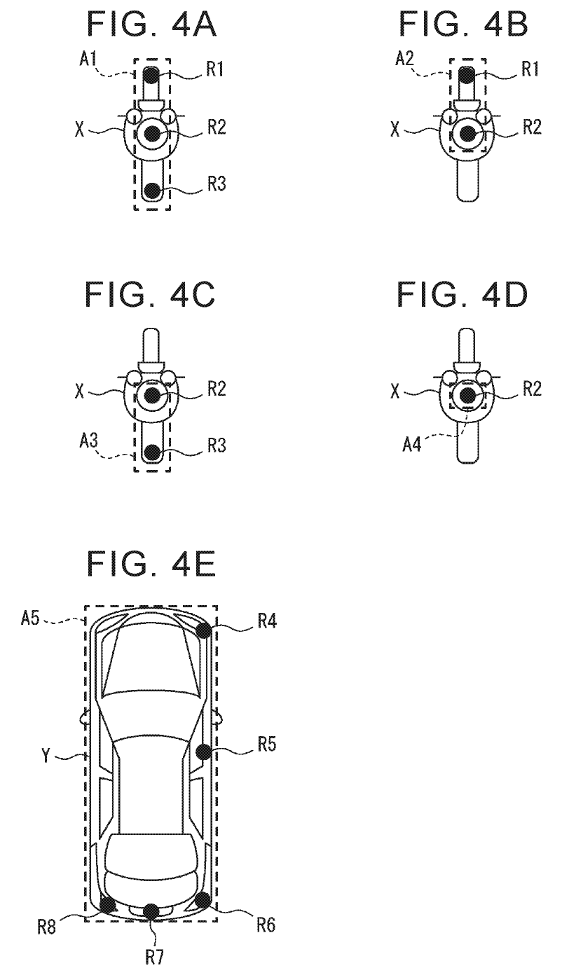

Reflection points at which radio waves transmitted from the millimeter-wave radar 11 are reflected by an object vary depending on the type and condition of the object. FIGS. 4A, 4B, 4C, 4D and 4E are diagrams schematically illustrating reflection points of radio waves transmitted from the millimeter-wave radar 11. In particular, FIGS. 4A, 4B, 4C, 4D and 4E illustrate reflection points on two-wheeled vehicles and on automobiles (including four-wheeled vehicles and large vehicles, but excluding two-wheeled vehicles).

For example, when a two-wheeled vehicle X is present in the left-front region around the vehicle 100, the millimeter-wave radar 11 detects reflected waves at, for example, three reflection points R1, R2, and R3, as illustrated in FIG. 4A. In this case, the object detection unit 331 detects an object by treating the three reflection points R1, R2, and R3 detected at positions close to each other as representing a single object. Accordingly, for example, the object detection unit 331 detects an object as being present in a region A1 indicated by a dashed line in FIG. 4A.

Since the region A1 recognized in this manner is not large, the detected object is estimated to be a two-wheeled vehicle rather than an automobile. In addition, since reflection of radio waves at the reflection points R1, R2, and R3 is caused by clothing of a person, wheels, and the like, the reflection intensity is relatively weak. This also leads to estimation that the detected moving object is a two-wheeled vehicle rather than an automobile. Accordingly, in the example shown in FIG. 4A, the object detection unit 331 estimates that a two-wheeled vehicle is present in the region A1.

However, as described above, in the case of a two-wheeled vehicle (in particular, a bicycle), radio waves from the millimeter-wave radar 11 are reflected by clothing of a person, wheels, and the like, and therefore the reflection intensity is weak. Therefore, in some cases, some reflection points may not be detected. FIGS. 4B, 4C, and 4D illustrate reflection points in cases where some reflection points are not detected.

In the example shown in FIG. 4B, reflection points at a rear portion of the two-wheeled vehicle X are not detected, and two reflection points R1, R2 are detected. In this case, the object detection unit 331 detects an object as being present in a small region A2 including the reflection points R1, R2. In the example shown in FIG. 4C, reflection points at a front portion of the two-wheeled vehicle X are not detected, and two reflection points R2, R3 are detected. In this case, the object detection unit 331 detects an object as being present in a small region A3 including the reflection points R2, R3. In the example shown in FIG. 4D, reflection points at the front portion and the rear portion of the two-wheeled vehicle X are not detected, and one reflection point R2 is detected. In this case, the object detection unit 331 detects an object as being present in an even smaller region A4 including the reflection point R2. In the cases shown in FIGS. 4B, 4C, and 4D as well, the object detection unit 331 estimates that the detected object is a two-wheeled vehicle based on the small number of reflection points and the reflection intensity.

On the other hand, for example, when an automobile Y is present in the left front region relative the vehicle 100, the millimeter-wave radar 11 detects reflected waves at a large number of reflection points R4 to R8 as shown in FIG. 4E. In this case, the object detection unit 331 detects a single object as being present in a region A5 including the large number of reflection points R4 to R8.

Since the region A5 recognized in this manner is relatively large, the detected object is estimated to be an automobile such as a four-wheeled vehicle. In addition, since reflection of radio waves at the reflection points R4 to R8 is caused by the vehicle body of an automobile, the reflection intensity is relatively strong. This also leads to estimation that the detected moving object is an automobile such as a four-wheel vehicle rather than a two-wheeled vehicle. Accordingly, in the example shown in FIG. 4E, the object detection unit 331 estimates that an automobile is present in the region A5.

As described above, in the present embodiment, the object detection unit 331 determines, based on the number of reflection points and the reflection intensity from a single object detected by the millimeter-wave radar 11, whether the object is a two-wheeled vehicle. Specifically, in the present embodiment, for example, when the number of reflection points detected at positions close to each other is less than or equal to a predetermined number (for example, three) and the average reflection intensity at these reflection points is lower than a predetermined intensity, the object detection unit 331 estimates that a two-wheeled vehicle is present in a region including the reflection points. On the other hand, for example, when the number of reflection points detected at positions close to each other exceeds a predetermined number (for example, three) and the average reflection intensity at these reflection points is greater than or equal to a predetermined intensity, the object detection unit 331 estimates that an automobile is present in a region including the reflection points. The object detection unit 331 then transmits information about the detected object (that is, information including the region in which the object is present and the type of the object) to the warning unit 332. The object detection unit 331 may determine, based on either the number of reflection points or the reflection intensity from a single object detected by the millimeter-wave radar 11, or based on other parameters in addition to the number of reflection points and/or the reflection intensity, whether the object is a two-wheeled vehicle.

The warning unit 332 receives the information about the object detected by the object detection unit 331 and issues a warning to the occupants of the vehicle 100 based on the object detected by the object detection unit 331. In particular, in the present embodiment, in a case where an object detected by the object detection unit 331 is estimated to be an automobile, the warning unit 332 issues a warning when the object is located within a predetermined normal warning region M to the side of the vehicle 100. In addition, in a case where an object detected by the object detection unit 331 is estimated to be a two-wheeled vehicle, the warning unit 332 issues a warning when the object is located within an extended warning region N obtained by extending the normal warning region M.

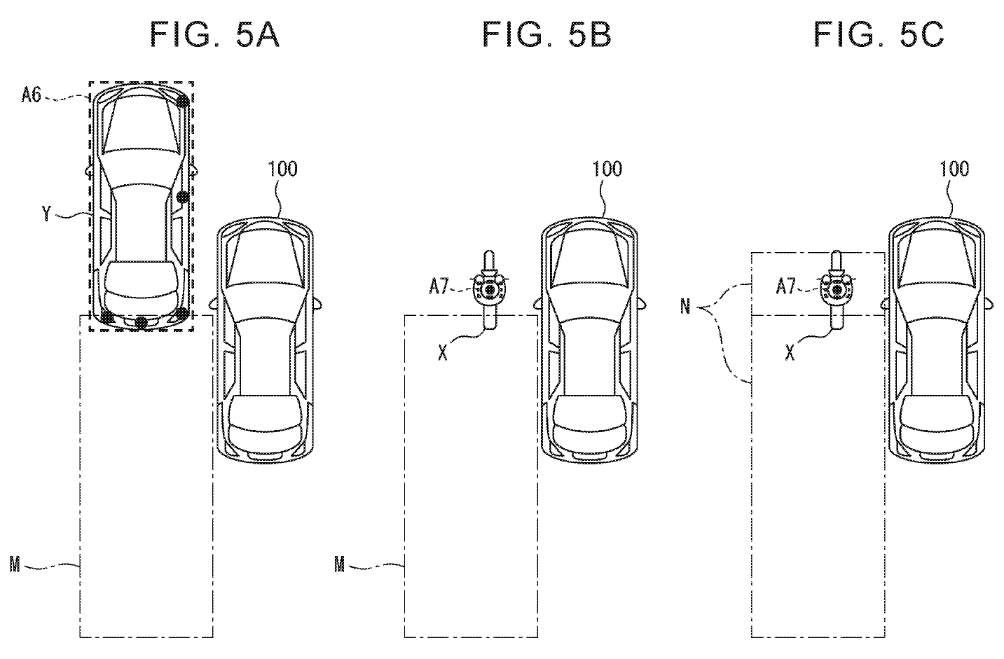

FIGS. 5A, 5B, and 5C are diagrams schematically illustrating warning regions used when a warning is issued by the warning unit 332. FIGS. 5A, 5B, and 5C illustrate warning regions to the left of the vehicle 100. However, such warning regions are also provided to the right of the vehicle 100.

FIG. 5A schematically illustrates the normal warning region M located to the left of the vehicle 100. As shown in FIG. 5A, in the present embodiment, the normal warning region M is a region that extends from the side of the vehicle 100 toward the rear of the vehicle 100. When at least part of a moving object detected by the object detection unit 331 is included within the normal warning region M, the warning unit 332 issues a warning to the occupants.

In the example shown in FIG. 5A, an automobile Y is present in the left front region relative to the vehicle 100. Accordingly, based on a large number of reflection points, the object detection unit 331 estimates that an automobile is present in a region A6. The region A6 estimated in this manner partially overlaps the normal warning region M, and therefore the warning unit 332 determines that an object (specifically, an automobile) is present within the normal warning region M. As a result, in the case shown in FIG. 5A, the warning unit 332 issues a warning to the occupants.

Specifically, in the present embodiment, the warning unit 332 outputs an activation signal that causes the display 16 to display a warning indicating that a moving object is present to the side of the vehicle 100. The warning unit 332 also outputs an activation signal that causes audio indicating that a moving object is present to the side of the vehicle 100 to be output from the speaker 17. The warning unit 332 may issue a warning to the occupants using output devices other than the display 16 and the speaker 17.

In the example shown in FIG. 5B, a two-wheeled vehicle X is present in the front-left region relative to the vehicle 100. In addition, in the example shown in FIG. 5B, reflection points at the front portion and the rear portion of the two-wheeled vehicle X are not detected, and one reflection point is detected. Accordingly, the object detection unit 331 detects an object as being present in a small region A7 including one reflection point.

In the example shown in FIG. 5B, part of the two-wheeled vehicle X is located within the normal warning region M. This is typically a situation in which a warning to the occupants is issued from the warning unit 332. However, as described above, since reflection points are not detected for part of the two-wheeled vehicle X, the object detection unit 331 detects the object as being present in a region smaller than the region in which the two-wheeled vehicle X is actually present. As a result, the region A7 detected by the object detection unit 331 as containing the object is not included at all within the normal warning region M, and therefore, if no further measures are taken, a warning is not issued from the warning unit 332 to the occupants. Consequently, although an object is present within a region where a warning to the occupants should be issued, no warning is issued, resulting in a delay in issuing the warning to the occupants.

FIG. 5C schematically illustrates the extended warning region N obtained by extending the normal warning region M located to the left of the vehicle 100 in the traveling direction of the vehicle 100. As shown in FIG. 5C, the extended warning region N extends from the side of the vehicle 100 toward the rear of the vehicle 100. In particular, in the present embodiment, the extended warning region N is a region obtained by extending the normal warning region M in the traveling direction of the vehicle 100 by a predetermined length. The predetermined length is equal to the length from the rear end to the center of a typical two-wheeled vehicle (bicycle) (for example, about one meter).

In the present embodiment, in a case where an object detected by the object detection unit 331 is estimated to be a two-wheeled vehicle, the warning unit 332 issues a warning to the occupants when at least part of the detected object is included within the extended warning region N.

In the example shown in FIG. 5C, the object detected by the object detection unit 331 is estimated to be a two-wheeled vehicle. Accordingly, the warning unit 332 determines whether the detected object is present within a warning region by using the extended warning region N rather than the normal warning region M. In the example shown in FIG. 5C, the region A7 detected by the object detection unit 331 as containing the object partially overlaps the extended warning region N, and therefore the warning unit 332 determines that an object (a two-wheeled vehicle) is present within the extended warning region N. As a result, in the case illustrated in FIG. 5C, the warning unit 332 issues a warning to the occupants.

As described above, in the present embodiment, in a case where an object detected by the object detection unit 331 is estimated to be a two-wheeled vehicle, a warning is issued when the object is located within the extended warning region N. Accordingly, even in a case where the object is a two-wheeled vehicle, when the object is present within a region where a warning to the occupants should be issued (the normal warning region M), a warning is issued to the occupants, thereby suppressing delays in issuing the warning.

When the object detection unit 331 performs detection of a two-wheeled vehicle, reflection points at a rear portion of the two-wheeled vehicle X are often not detected, as shown in FIGS. 4B and 4D. In contrast, in the present embodiment, the extended warning region N is a region obtained by extending the normal warning region M forward by a length equal to the length from the rear end to the center of a typical two-wheeled vehicle (bicycle), for example, about one meter. Therefore, even in cases where reflection points at the rear portion of the two-wheeled vehicle X are not detected, a warning can be appropriately issued to the occupants. At the same time, unnecessary expansion of the warning region is suppressed, and the possibility that a warning to the occupants is issued when no object is present within the normal warning region M is reduced.

In the present embodiment, the extended warning region N is described as a region obtained by extending the normal warning region M in the traveling direction of the vehicle 100 by a predetermined length. However, the extended warning region N may alternatively be a region obtained by additionally extending the normal warning region M rearward of the vehicle 100 by a predetermined length, or a region obtained by extending the normal warning region M rearward of the vehicle 100 by a predetermined length. Alternatively, the extended warning region N may be a region obtained by additionally extending the normal warning region M outward in the width direction of the vehicle 100 by a predetermined length, or a region obtained by extending the normal warning region M outward in the width direction of the vehicle 100 by a predetermined length.

### Control Flow

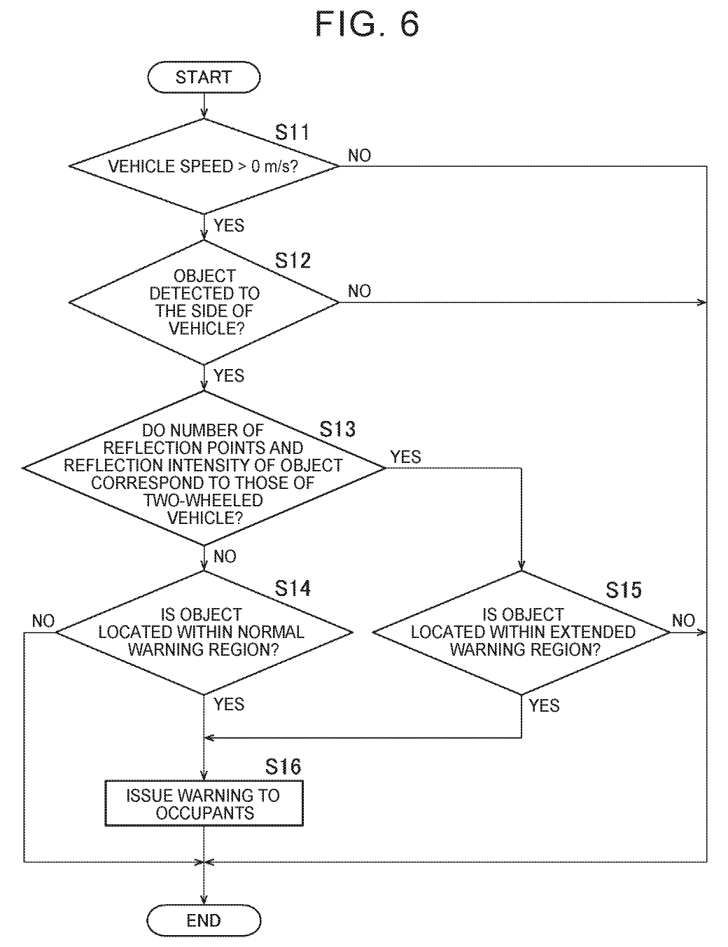

Next, the flow of a warning process executed by the warning device will be described with reference to FIG. 6. FIG. 6 is a flowchart illustrating the warning process. The warning process shown in FIG. 6 is executed by the processor 33 at predetermined time intervals.

As shown in FIG. 6, the warning unit 332 first determines, based on output data from the vehicle speed sensor 12, whether the speed of the vehicle 100 is greater than 0 m/s, that is, whether the vehicle 100 is traveling (S11). When it is determined in S11 that the speed of the vehicle 100 is 0 m/s, the warning process ends because no warning to the occupants will be issued.

On the other hand, when it is determined in S11 that the speed of the vehicle 100 is greater than 0 m/s, the warning unit 332 determines whether an object is detected to the side of the vehicle 100 (including the front side and rear side regions relative to the vehicle 100) by the object detection unit 331 (S12). When it is determined in S12 that no object is detected to the side of the vehicle 100, the warning process ends because no warning to the occupants will be issued. When it is determined in S12 that an object is detected in a region extending from the side of the vehicle 100 toward the rear of the vehicle 100, the warning unit 332 determines whether the number of reflection points and the reflection intensity of the detected object correspond to those of a two-wheeled vehicle (S13). That is, the warning unit 332 determines whether the detected object is a two-wheeled vehicle.

When it is determined in S13 that the number of reflection points and the reflection intensity of the detected object do not correspond to those of a two-wheeled vehicle, the warning unit 332 determines whether the detected object is located within the normal warning region M (S14). Specifically, the warning unit 332 determines whether a region estimated by the object detection unit 331 to contain the object is at least partially located within the normal warning region M. When it is determined in S14 that the detected object is located within the normal warning region M, the warning unit 332 issues a warning to the occupants (S16). Specifically, the warning unit 332 causes a warning display to be displayed on the display 16 and outputs audio indicating a warning from the speaker 17. On the other hand, when it is determined in S14 that the detected object is not located within the normal warning region M, the warning process ends because no warning to the occupants will be issued.

When it is determined in S13 that the number of reflection points and the reflection intensity of the detected object correspond to those of a two-wheeled vehicle, the warning unit 332 determines whether the detected object is located within the extended warning region N (S15). Specifically, the warning unit 332 determines whether a region estimated by the object detection unit 331 to contain the object is at least partially located within the extended warning region N. When it is determined in S15 that the detected object is located within the extended warning region N, the warning unit 332 issues a warning to the occupants (S16). On the other hand, when it is determined in S15 that the detected object is not located within the extended warning region N, the warning process ends because no warning to the occupants will be issued.

Although the preferred embodiments of the present disclosure have been described above, the present disclosure is not limited to these embodiments, and various modifications and changes may be made within the scope of the claims.

What is claimed is:

1. A warning device configured to issue a warning to a user of a vehicle when an object is present around the vehicle, the warning device comprising:
an object detection unit configured to detect objects around the vehicle; and
a warning unit configured to issue a warning to the user of the vehicle based on an object detected by the object detection unit,
wherein the warning unit is configured to, in a case where the object detected by the object detection unit is estimated to be an automobile, issue a warning to the user of the vehicle when the object is located within a predetermined normal warning region to a side of the vehicle, and in a case where the object detected by the object detection unit is estimated to be a two-wheeled vehicle, issue a warning to the user of the vehicle when the object is located within an extended warning region obtained by extending the predetermined normal warning region.

2. The warning device according to claim 1, wherein the object detection unit is configured to detect objects based on output of a radar mounted on the vehicle.

3. The warning device according to claim 2, wherein the object detection unit is configured to determine, based on the number of reflection points and reflection intensity from a single object detected by the radar, whether the single object is a two-wheeled vehicle.

4. The warning device according to claim 1, wherein the extended warning region is a region obtained by extending the predetermined normal warning region in a traveling direction of the vehicle.

5. A non-transitory storage medium storing a warning program that causes a warning to be issued to a user of a vehicle when an object is present around the vehicle, the warning program causing a computer to
detect objects around the vehicle,
in a case where a detected object is estimated to be an automobile, issue a warning to the user of the vehicle when the detected object is located within a predetermined normal
warning region to a side of the vehicle, and in a case where the detected object is estimated to be a two-wheeled vehicle, issue a warning to the user of the vehicle when the detected object is located within an extended warning region obtained by extending the predetermined normal warning region.
